(19) United States
(12) Patent Application Publication
(10) Pub. No.: US 2007/0286116 A1
(43) Pub. Date: Dec. 13, 2007

(54) Wireless bridging method for wireless IEEE 1394 network environment and wireless bridge apparatus thereof

(75) Inventors: Keun-joo Park, Yongin-si (KR); Hyun-chin Kim, Seongnam-si (KR); Young-kwang Seo, Seoul (KR); Yeong-bae Yeo, Daegu (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/646,389

(22) Filed: Dec. 28, 2006

(30) Foreign Application Priority Data
Jun. 7, 2006 (KR) 2006-50975

(51) Int. Cl. H04Q 7/00

(52) U.S. Cl. 370/328

(57) ABSTRACT

A wireless bridging method for a wireless IEEE 1394 network environment includes receiving information about IEEE 1394 devices contained in an external cluster from the external cluster, and if the information on the IEEE 1394 devices contained in the external cluster is received from the external cluster, resetting a bus of a cluster. According to the method, an effective wireless 1394 bridge supporting a conventional 1394 devices having no bridge awareness function can be implemented.

### CROSS-REFERENCE TO RELATED APPLICATIONS

This application claims the benefit of Korean Patent Application No. 2006-50975 filed on Jun. 7, 2006, in the Korean Intellectual Property Office, the disclosure of which is incorporated herein by reference in its entirety.

### BACKGROUND OF THE INVENTION

1. Field of the Invention

Aspects of the present invention relate to a wireless bridging method for a wireless IEEE 1394 network environment and a wireless bridge apparatus thereof, and more particularly, to a wireless bridging method for a wireless IEEE 1394 network environment and a wireless bridge apparatus made of conventional 1394 devices having no bridge awareness function.

2. Description of the Related Art

The IEEE 1394 bus has recently become regarded as an important communication system having synchronous and asynchronous transmission capability in the field of home systems. The implementation of the 1394-based home network has been accelerated.

The IEEE 1394 serial bus has been internationally standardized and widely used as a bus for data exchange between terminals in consumer electronics and computer manufacturing industries. Specifically, the IEEE 1394 bus standard is the IEEE standard for a high performance serial bus described in (IEEE) STD 1394-1995, IEEE New York, August 1996. An improved version of the IEEE 1394 serial bus was finalized in the year 2000, named the IEEE 1394-2000 (2^{nd} Edition).

The IEEE 1394 bus is a wired bus. A maximum of 63 stations can participate in the communication over the bus lines, and the maximum distance between two stations is 4.5 meters.

However, a bus cable should be installed in every room where a bus station is located. Installing a bus cable in every room where a station is located is a problem because the maximum allowable distance between stations is 4.5 meters. Thus, there is a need for a wireless extension of the IEEE 1394 standard. The IEEE 1394.1 standard was recently defined due to the above necessity.

The 1394.1 bridge provided in the wireless 1394 network based on the IEEE 1394.1 standard supports only 1394 devices having a bridge awareness function. That is, in order to implement the wireless 1394 bridge and comply with the IEEE standard, all of the 1394 devices should have the bridge awareness function.

Therefore, the conventional wireless 1394.1 bridge cannot support a conventional 1394 device, i.e., a 1394 device using the IEEE 1394-2000 serial bus.

### SUMMARY OF THE INVENTION

An aspect of the present invention provides a wireless bridging method for a wireless 1394 network environment and a wireless bridge apparatus made of conventional 1394 devices having no bridge awareness function.

The foregoing and/or other objects and advantages are substantially realized by providing a wireless bridging method for a wireless IEEE 1394 network environment, according to aspects of the present invention, which includes transmitting information about IEEE 1394 devices contained in an external cluster from the external cluster to a cluster, and resetting a bus of the cluster if the information about the IEEE 1394 devices contained in the external cluster is received by the cluster from the external cluster.

The resetting of the bus of the cluster may include generating self-IDs of the IEEE 1394 devices contained in the cluster in succession.

The wireless bridging method may further include transmitting the information about the IEEE 1394 devices contained in the cluster to the external cluster.

The resetting of the bus of the cluster may include creating a routing table containing IDs of the 1394 devices included in the cluster and the generated self-IDs and original IDs of the 1394 devices contained in the external cluster.

The external cluster and the cluster may employ an IEEE 1394 system.

The cluster may transmit an IEEE 1394 signal based on the original ID of the IEEE 1394 devices corresponding to the generated self-IDs of the IEEE 1394 devices using the routing table.

The wireless bridging method may further include receiving information on IEEE 1394 devices removed or added from the external cluster if any one of the IEEE 1394 devices contained in the external cluster is removed or added.

If any one of the IEEE 1394 devices contained in the cluster requests wireless communication to a removed IEEE 1394 device, the cluster rejects the request for wireless communication.

The information about the IEEE 1394 devices may include an original ID and the type of IEEE 1394 device.

According to another aspect of the present invention, a wireless bridge apparatus includes a wireless interface contained in a cluster to wirelessly receive information about IEEE 1394 devices contained in an external cluster from the external cluster, and a controller contained in the cluster to reset a bus of the cluster if the information about the IEEE 1394 devices contained in the external cluster is received by the wireless interface.

The wireless interface may be divided into a physical layer section to generate self-IDs of the IEEE 1394 devices in succession, and a link layer section to recognize the generated self-IDs.

The controller may create a routing table to store IDs of the IEEE 1394 devices included in the cluster and the generated self-IDs and original IDs of the IEEE 1394 devices.

The controller may transmit an IEEE 1394 signal based on the original IDs of the IEEE 1394 devices corresponding to the generated self-IDs of the IEEE 1394 devices using the routing table.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments of the invention, taken in conjunction with the accompanying drawings of which:

FIG. 1 is a view illustrating a wireless IEEE 1394 network according to an embodiment of the present invention;

FIG. 2 is a block diagram of a wireless bridge apparatus used in the wireless IEEE 1394 network of FIG. 1, according to an embodiment of the present invention;

FIG. 3 is a flowchart explaining a wireless bridging method of the wireless bridging apparatus shown in FIG. 2, according to an embodiment of the present invention;

FIG. 4 is a view illustrating the local bus reset method shown in FIG. 3;

FIG. 5 is a view illustrating the inter-bridge communication method shown in FIG. 3; and

FIG. 6 is a view illustrating the global bus reset method shown in FIG. 3

### DETAILED DESCRIPTION OF THE EMBODIMENTS

Reference will now be made in detail to embodiments of the invention, examples of which are illustrated in the accompanying drawings, wherein like reference numerals refer to like elements throughout. The embodiments are described below in order to explain the invention by referring to the figures.

Specific examples in the description of a detailed construction and specific elements are merely provided to assist in a comprehensive understanding of the invention. Thus, it is apparent that the invention can be carried out without these specific examples. Also, well-known functions or constructions are not described in detail to avoid obscuring the invention with unnecessary detail.

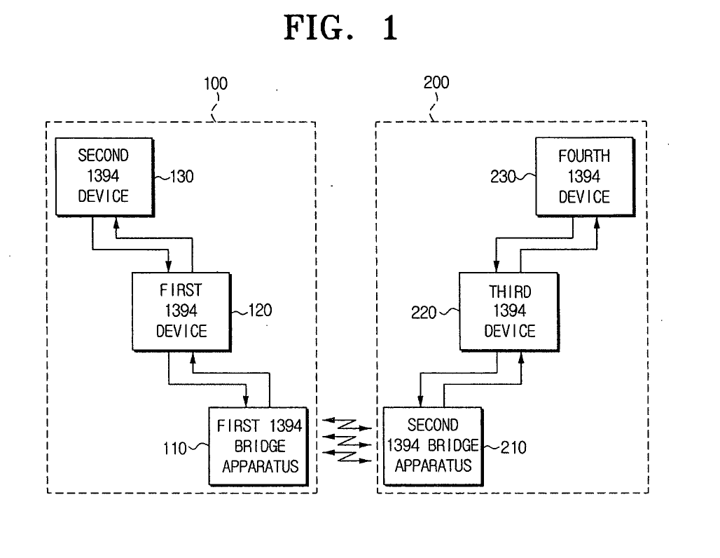

FIG. 1 is a view illustrating a wireless IEEE 1394 network according to an embodiment of the present invention.

Referring to FIG. 1, the wireless IEEE 1394 network (referred to as wireless 1394 network) includes at least two local clusters. For example, the wireless 1394 network may include a first local cluster 100 and a second local cluster 200.

The first local cluster 100 is a 1394 bus including a first wireless 1394 bridge apparatus 110 (referred to as “wireless bridge apparatus”) to communicate wirelessly with the second local cluster 200, and first and second 1394 devices 120 and 130, respectively, which are both connected to the first wireless bridge apparatus 110 via a 1394 cable or cables. It is understood, however, that the first and second 1394 devices 120 and 130 do not necessarily have to connect to the first wireless bridge apparatus 110 via a 1394 cable or cables, but can also be connected in another fashion, such as wirelessly.

The second local cluster 200 is a 1394 bus including a second wireless 1394 bridge apparatus 210 to communicate wirelessly with the second wireless 1394 bridge apparatus 110 provided in the first local cluster 100, and third and fourth 1394 devices 220 and 230, which are both connected to the second wireless bridge apparatus 210 via a 1394 cable. The first local cluster 100 may be referred to as a cluster, and the second local cluster 200 may be referred to as an external cluster.

The first through fourth 1394 devices 120, 130, 220, and 230, respectively, may be consumer electronics devices such as a TV receiver, VCR, camcorder, set top box, DVD player, PC, as well as other devices. Each of these devices should conform to the 1394 standard.

The first and second 1394 devices 120 and 130 provided in the first local cluster 100 are wirelessly connected with the third and fourth 1394 devices 220 and 230 provided in the second local cluster 200 via the first and second wireless bridge apparatuses 110 and 210. A UWB (ultra wideband) transmission technology may be used for the wireless connection. However, it is understood that other types of wireless technologies may also be used for the wireless connection.

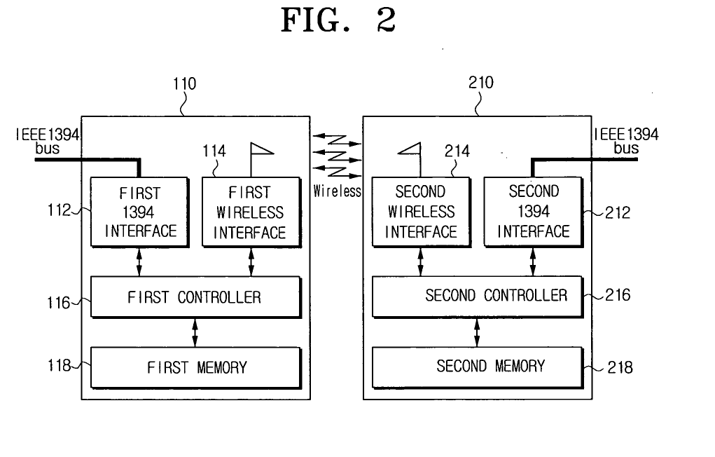

FIG. 2 is a block diagram of the wireless bridge apparatus used in the wireless IEEE 1394 shown in FIG. 1. Referring to FIG. 2, the first wireless bridge apparatus 110 includes a first 1394 interface 112, a first wireless interface 114, a first controller 116, and a first memory 118. Similarly, the second wireless bridge apparatus 210 includes the same construction as that of the first wireless bridge apparatus 110.

The first 1394 interface 112 transmits and/or receives an IEEE 1394 type cable signal to and/or from the first and second 1394 devices 120 and 130 via the 1394 cable, i.e., the IEEE 1394 bus. Specifically, the first 1394 interface 112 is subdivided into two parts, i.e., a physical layer section and a data link layer section. The physical layer section generates a self-ID packet, and the data link layer section recognizes a plurality of IDs.

The first wireless interface 114 provides a USB communication interface to transmit and/or receive a USB type wireless signal to and/or from the second wireless interface 214. The first controller 116 controls the operations of a local bus reset, an inter-bridge communication, and a global bus reset.

The first memory 118 stores a routing table. The routing table includes IDs of the first and second 1394 devices 120 and 130 connected to the first wireless bridge apparatus 110 via the IEEE 1394 bus. The first memory 118 also stores newly allocated IDs and original IDs of the third and fourth 1394 devices 220 and 230 which are connected to the second wireless bridge apparatus 210 via the IEEE 1394 bus.

The construction of the second wireless bridge apparatus 210 is similar to that of the first wireless bridge apparatus 110, and thus will be not described herein.

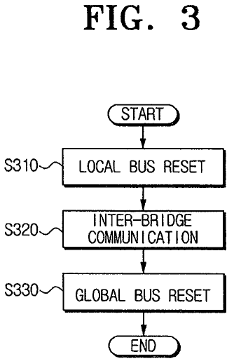

FIG. 3 is a flowchart explaining a wireless bridging method of the wireless bridge apparatus shown in FIG. 2, according to an embodiment of the present invention. Referring to FIG. 3, if a new 1394 device is connected with the first and second wireless bridge apparatuses 110 and 210 or the 1394 device previously connected is disconnected from the apparatuses, the first and second wireless bridge apparatuses 110 and 210 perform a local bus reset operation (S310). Specifically, if the local bus reset takes place in the first local cluster 100, the first wireless bridge apparatus 110 acts as a branch and the first and second 1394 devices 120 and 130 each act as a leaf. At this point, the first wireless bridge apparatus 110 and the first and second 1394 devices 120 and 130 allocate self-IDs in accordance with tree identification. The physical layer sections of the 1394 interface provided in the first wireless bridge apparatus 110 and the first and second 1394 devices 120 and 130 all generate a self-ID packet containing the self-IDs, and transmit the packet to each other via the IEEE 1394 bus.

Similarly, if the local bus reset takes place in the second local cluster 200, the second wireless bridge apparatus 210 and the third and fourth 1394 devices 220 and 230 perform the local bus reset operation (S310), as described above. As such, the first wireless bridge apparatus 110 receives the IDs of the first and second 1394 devices 120 and 130 connected thereto, and the second wireless bridge apparatus 210 receives the IDs of the third and fourth 1394 devices 220 and 230 connected thereto.

According to an aspect of the invention, the first controller 116 of the first wireless bridge apparatus 110 stores the IDs of the first and second 1394 devices 120 and 130, and the second controller 216 of the second wireless bridge apparatus 210 stores the IDs of the third and fourth 1394 devices 220 and 230. However, it is understood that the IDs of the first, second, third and fourth devices 110, 120, 210 and 220 may be stored in places other than the first and second controllers 116 and 216.

Then, the first wireless bridge apparatus 110 and the second wireless bridge apparatus 210 perform the inter-bridge communication operation (S320). That is, the first wireless bridge apparatus 110 transmits and/or receives wireless signals to and/or from the second wireless bridge apparatus 210. More specifically, the first controller 116 of the first wireless bridge apparatus 110 transmits the information about the first and second 1394 devices 120 and 130 to the second wireless bridge apparatus 210 via the first wireless interface 114, and the second controller 216 of the second wireless bridge apparatus 210 transmits the information about the third and fourth 1394 devices 220 and 230 to the first wireless bridge apparatus 110 via the second wireless interface 214. The device information includes ID information of the device, a description of the type of device, and other information as well.

Thus, the first wireless bridge apparatus 110 receives information regarding the third and fourth 1394 devices 220 and 230 connected to the second wireless bridge apparatus 210, and the second wireless bridge apparatus 210 receives information regarding the first and second 1394 devices 120 and 130 connected to the first wireless bridge apparatus 110.

Then, the first and second wireless bridge apparatuses 110 and 210 perform the global bus reset operation (S330). The global bus reset operation (S330) is performed in the same succession as the local bus reset operation (S310). However, in the global bus reset operation, the first wireless bridge apparatus 110 allocates new IDs to the third and fourth 1394 devices 220 and 230 connected to the second wireless bridge apparatus 210 which have been transmitted and received through the inter-bridge communication operation (S320), as well as the self-ID packet of the first wireless bridge apparatus 110, and sequentially generates the self-ID packets containing the newly allocated IDs.

Similarly, during the global bus reset operation (S330), the second wireless bridge apparatus 210 allocates new IDs to the first and second 1394 devices 120 and 130 connected to the first wireless bridge apparatus 110, and sequentially generates the self-ID packets containing the newly allocated IDs.

Thus, the first and second 1394 devices 120 and 130 connected to the first wireless bridge apparatus 110 receive the newly allocated IDs corresponding to the third and fourth 1394 devices 220 and 230 which are connected to the second wireless bridge apparatus 210. In other words, the first and second 1394 devices 120 and 130 recognize that the third and fourth 1394 devices 220 and 230 are connected to the first wireless bridge apparatus 110.

Furthermore, the third and fourth 1394 devices 220 and 230 connected to the second wireless bridge apparatus 210 receive the newly allocated IDs corresponding to the first and second 1394 devices 120 and 130 which are connected to the first wireless bridge apparatus 110. In other words, the third and fourth 1394 devices 220 and 230 recognize that the first and second 1394 devices 120 and 130 are connected to the second wireless bridge apparatus 210.

According to an embodiment of the present invention, the first controller 116 of the first wireless bridge apparatus 110 generates the routing table including the IDs of the first and second 1394 devices 120 and 130, the newly allocated IDs of the third and fourth 1394 devices 220 and 230, and the original IDs of the third and fourth 1394 devices 220 and 230, and stores the routing table in the first memory 118. Similarly, the second controller 216 of the second wireless bridge apparatus 210 generates the routing table including the IDs of the third and fourth 1394 devices 220 and 230, the newly allocated IDs of the first and second 1394 devices 120 and 130, and the original IDs of the first and second 1394 devices 120 and 130, and stores the routing table in the second memory 218. However, it is understood that components other than the first and second controllers 116 and 216 may generate the routing tables, and it is further understood that components other than the first and second memories 118 and 218 may store the routing tables.

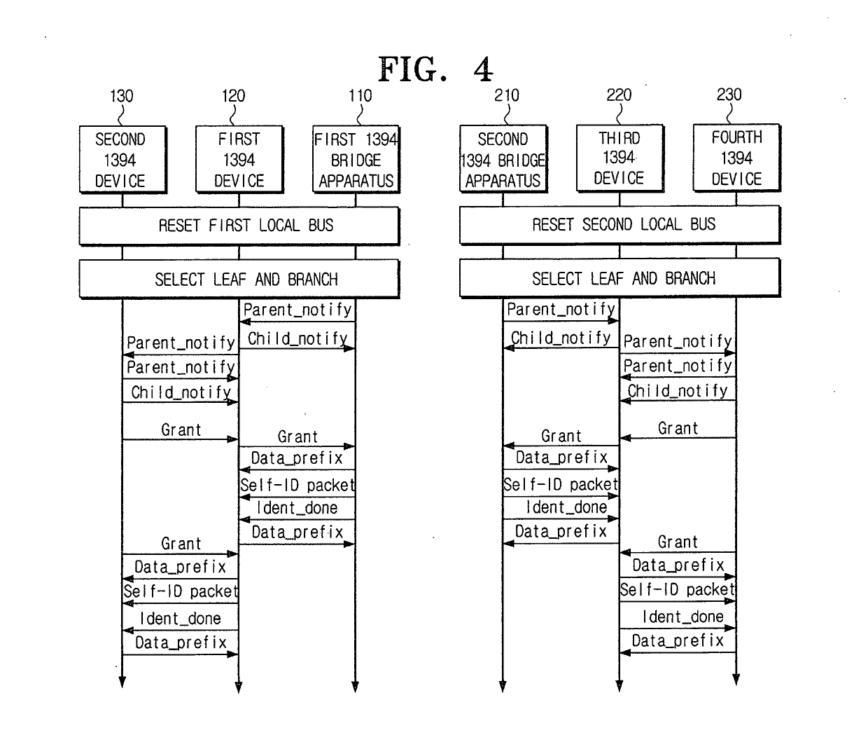

FIG. 4 is a view illustrating the local bus reset operation shown in FIG. 3. Referring to FIG. 4, if the first local bus reset operation (S310) takes place, the first wireless bridge apparatus 110 and the first and second 1394 devices 120 and 130 act as a branch and two leaves, respectively. Herein, the first wireless bridge apparatus 110 acts as the branch, that is, a root, while the first and second 1394 devices 120 and 130 each act as a leaf. The first wireless bridge apparatus 110, which is acting as the root, transmits a message “Parent_notify” to the first and second 1394 devices 120 and 130, while the first and second 1394 devices 120 and 130 transmit a message “Child_notify” to the first wireless bridge apparatus 110. It is understood that messages other than “Parent_notify” and “Child_notify” may be respectively transmitted by the first wireless bridge apparatus 110 and the first and second 1394 devices 120 and 130.

The first wireless bridge apparatus 110 allocates an ID “0” as a self-ID, and the first and second 1394 devices 120 and 130 respectively allocate IDs “1” and “2” as self-IDs. Each component in the first local cluster 100 thus generates a self-ID packet including the ID allocated to itself, and then transmits its self-ID packet to the other component via the IEEE 1394 bus. It is understood that IDs other than “0”, “1” and “2” may be used to respectively indicate the first wireless bridge apparatus 110 and the first and second 1394 devices 120 and 130.

The second local bus reset method is similar to the first local bus reset method, and thus will not be described herein.

If one cluster is connected with a new 1394 device or the 1394 device previously connected is removed, the local bus reset takes place, but a local bus reset signal is not transmitted. If the 1394 device previously connected is removed and thus the local bus reset takes place, only the information that the 1394 device previously connected has been removed is transmitted to the wireless bridge apparatus. If a 1394 device positioned in another cluster attempts to wirelessly communicate with the removed 1394 device, the wireless bridge apparatus which was previously connected to removed 1394 device rejects the attempt.

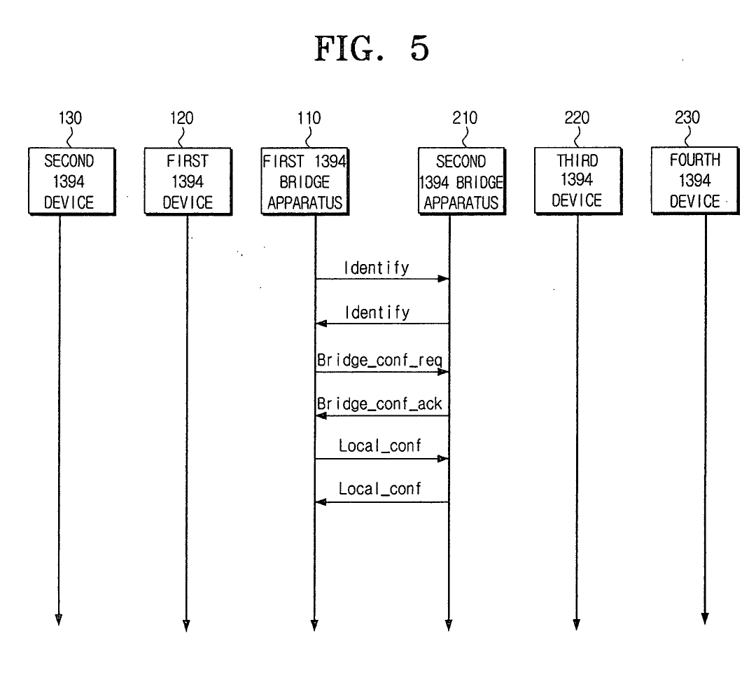

FIG. 5 is a view illustrating the inter-bridge communication operation (S32) shown in FIG. 3. Referring to FIG. 5, the first and second wireless bridge apparatuses 110 and 210 transmit and receive a message “Identify” to identify each other. The second wireless bridge apparatus 210 transmits a message “Bridge_conf_req,” which requests the bridge configuration to the first wireless bridge apparatus 110, while the first wireless bridge apparatus 110 transmits a message “Bridge_conf_ack,” which responds to the request of bridge configuration transmitted by the second wireless bridge apparatus 210. It is understood that messages other than “Identify,” “Bridge_conf_req,” and “Bridge_conf_ack” may be transmitted during the inter-bridge communication operation (S320).

In the response to the request of bridge configuration, the first wireless bridge apparatus 110 transmits a message “Local_conf” to the second wireless bridge apparatus 210, which contains the information regarding the first and second 1394 devices 120 and 130 connected to the first wireless bridge apparatus 110, while the second wireless bridge apparatus 210 transmits a message “Local_conf” to the first wireless bridge apparatus 110 which contains the information of the third and fourth 1394 devices 220 and 230 connected to the second wireless bridge apparatus. It is understood that messages other than “Local_conf” may be transmitted during the inter-bridge communication operation (S320).

As a result, the first wireless bridge apparatus 110 receives the IDs, types, and other information of the 1394 devices connected to the second wireless bridge apparatus 210, while the second wireless bridge apparatus 210 receives the IDs, types, and other information of the 1394 devices connected to the first wireless bridge apparatus 110.

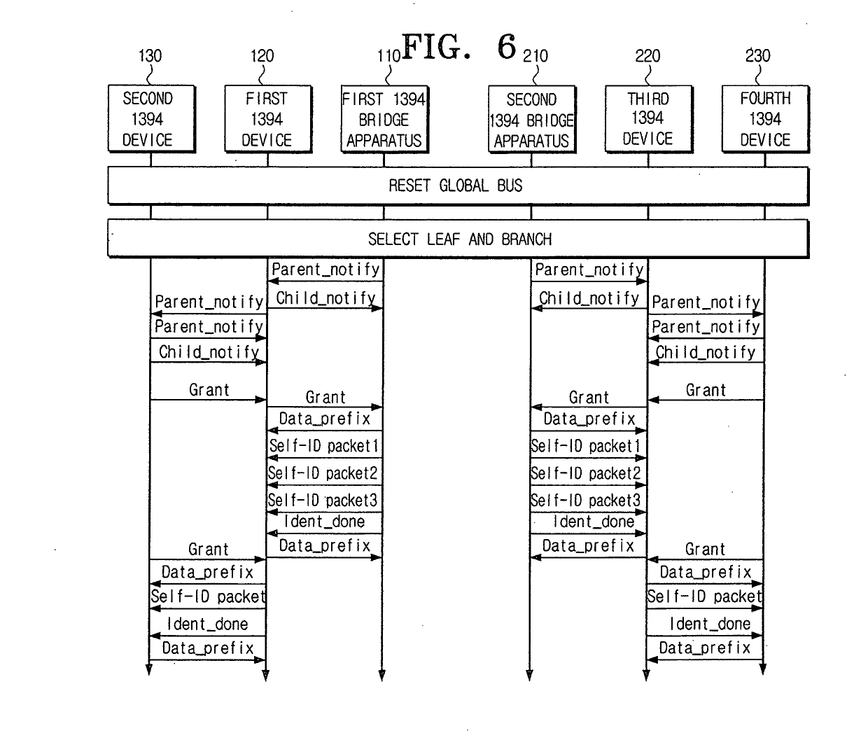

FIG. 6 is a view illustrating the global bus reset operation (S330) explained in FIG. 3. Referring to FIG. 6, if the global bus reset takes place, the first wireless bridge apparatus 110 and the first and second 1394 devices 120 and 130 act as a branch and two leaves, respectively, while the second wireless bridge apparatus 210 and the third and fourth 1394 devices 220 and 230 also act as a branch and two leaves, respectively. The sequence from the selection operation to the tree identification operation may be, but is not necessarily, identical to the local bus reset operation.

When the self-ID packet is generated, the first wireless bridge apparatus 110 generates a self-ID packet 1 containing the ID “0” thereof, allocates the IDs “1” and “2” to the third and fourth 1394 devices 220 and 230 to generate additional self-ID packets 2 and 3, and transmits the self-ID packets to the first and second 1394 devices 120 and 130. Consequently, the IDs of the first and second 1394 devices 120 and 130 become IDs “3” and “4”. The second wireless bridge apparatus 210 generates a self-ID packet 1, generates additional self-ID packets 2 and 3 corresponding to the first and second 1394 devices 120 and 130, and transmits the self-ID packets to the third and fourth 1394 devices 220 and 230.

As a result, the first and second 1394 devices 120 and 130 recognize that the third and fourth 1394 devices 220 and 230 are connected with the first wireless bridge apparatus 110. Further, the third and fourth 1394 devices 220 and 230 recognize that the first and second 1394 devices 120 and 130 are connected with the second wireless bridge apparatus 210.

By way of an example, the second 1394 device 130 transmits a 1394 signal to the first wireless bridge apparatus 110 by appointing a destination address as the ID “1” of the third 1394 device 220 in order to transmit the 1394 signal to the third 1394 device 220. The link layer section of the first 1394 interface 112 of the first wireless bridge apparatus 110 identifies the ID of the third 1394 device 220. The first controller 116 of the first wireless bridge apparatus 110 converts the original ID of the third 1394 device 220 corresponding to the ID “1” of the third 1394 device 220 into the destination address using the routing table stored in the first memory 118, and transmits the destination address to the second wireless bridge apparatus 210. The second wireless bridge apparatus 210 transmits the received 1394 signal to the third 1394 device 220 in accordance with the destination address.

Hereinbefore, a wireless bridge apparatus and a method of using the wireless bridge apparatus with a wireless 1394 network environment comprising two clusters, each cluster containing two 1394 devices, has been shown and described. However, the preceding descriptions merely reflect one example. Aspects of the present invention can also be used with clusters that contain one or more than two 1394 devices. Furthermore, aspects of the present invention can be applied to a wireless 1394 network environment comprising more than two clusters.

As described above, according to aspects of the present invention, the effective 1394 bridge capable of supporting conventional 1394 devices having no bridge awareness function can be implemented.

Although several embodiments of the invention have been shown and described, it would be appreciated by those skilled in the art that changes may be made in these embodiments without departing from the principles and spirit of the invention, the scope of which is defined in the claims and their equivalents.

What is claimed is:

1. A wireless bridging method for a wireless IEEE 1394 network environment, comprising:
transmitting information about IEEE 1394 devices contained in an external cluster from the external cluster to a cluster; and
resetting a bus of the cluster if the information about the IEEE 1394 devices contained in the external cluster is received by the cluster from the external cluster.

2. The wireless bridging method of claim 1, wherein the resetting of the bus of the cluster comprises generating self-IDs of the IEEE 1394 devices contained in the cluster in succession.

3. The wireless bridging method of claim 1, further comprising transmitting the information about IEEE 1394 devices contained in the cluster to the external cluster.

4. The wireless bridging method of claim 2, wherein the resetting of the bus of the cluster comprises creating a routing table to store IDs of the IEEE 1394 devices contained in the cluster, along with generated self-IDs and original IDs of the 1394 devices contained in the external cluster.

5. The wireless bridging method of claim 1, wherein the external cluster and the cluster employ an IEEE 1394 system.

6. The wireless bridging method of claim 4, wherein the cluster transmits an IEEE 1394 signal based on the generated self-IDs of the IEEE 1394 devices corresponding to the original IDs of the IEEE 1394 devices using the routing table.

7. The wireless bridging method of claim 1, further comprising transmitting information from the external cluster to the cluster about IEEE 1394 devices added to or removed from the external cluster if any one of the IEEE 1394 devices contained in the external cluster is added or removed.

8. The wireless bridging method of claim 7, wherein the external cluster rejects a request from the cluster to wirelessly communicate if any one of the IEEE 1394 devices contained in the cluster requests to wirelessly communicate with the deleted IEEE 1394 device.

9. The wireless bridging method of claim 1, wherein the information about the IEEE 1394 devices comprises original IDs and types of the IEEE 1394 devices.

10. The wireless bridging method of claim 1, wherein the IEEE 1394 devices comprise a TV receiver, a VCR, a camcorder, a set top box, a DVD player, and/or a PC.

11. The wireless bridging method of claim 1, wherein the cluster and the external cluster exchange information using ultra wideband (UWB) transmission technology.

12. A wireless bridge apparatus contained in a cluster, comprising:
a wireless interface to wirelessly receive information about IEEE 1394 devices contained in an external cluster from the external cluster; and
a controller to reset a bus of the cluster if the information about the IEEE 1394 devices contained in the external cluster is received by the wireless interface.

13. The wireless bridge apparatus of claim 12, wherein the wireless interface comprises:
a physical layer section to generate self-IDs of the IEEE 1394 devices in succession; and
a link layer section to link the generated self-IDs to the corresponding IEEE 1394 devices.

14. The wireless bridge apparatus of claim 12, wherein the controller creates a routing table to store IDs of the 1394 devices contained in the cluster, along with generated self-IDs and original IDs of the 1394 devices contained in the external cluster.

15. The wireless bridge apparatus of claim 14, wherein the controller transmits an IEEE 1394 signal based on the generated self-IDs of the IEEE 1394 devices corresponding to the original IDs of the IEEE 1394 devices using the routing table.

16. The wireless bridging method of claim 12, wherein the IEEE 1394 devices comprise a TV receiver, a VCR, a camcorder, a set top box, a DVD player, and/or a PC.

17. The wireless bridging method of claim 12, wherein the cluster and the external cluster exchange information using ultra wideband (UWB) transmission technology.

18. A wireless bridge apparatus, comprising:
an IEEE 1394 interface to connect with at least one IEEE 1394 device;
a controller to control local bus reset, inter-bridge communication, and global bus reset operations;
a memory to store a routing table which contains self-IDs of the wireless bridge apparatus and the at least one IEEE 1394 device; and
a wireless interface to wirelessly communicate with at least another wireless interface connected to another wireless bridge apparatus and at least another IEEE 1394 device.

19. The wireless bridge apparatus of claim 18, wherein the IEEE 1394 interface connects to the at least one IEEE 1394 device by at least one cable.

20. The wireless bridge apparatus of claim 18, wherein the controller activates the local bus reset, inter-bridge communication, and global bus reset operations when the at least one IEEE 1394 device is connected to or detached from the IEEE 1394 interface.

21. The wireless bridge apparatus of claim 20, wherein the local bus reset operation comprises the at least one IEEE 1394 device generating and transmitting the self-ID to the routing table.

22. The wireless bridge apparatus of claim 21, wherein the inter-bridge communication operation comprises the wireless interface transmitting the self-IDs stored in the routing table to the at least another wireless interface, and receiving self-IDs from the at least another wireless interface to store in the routing table.

23. The wireless bridge apparatus of claim 22, wherein the global bus reset operation comprises the wireless bridge apparatus generating new self-IDs based on the self-IDs stored in the routing table after the inter-bridge communication operation.

24. The wireless bridge apparatus of claim 18, wherein the wireless interface comprises:
a physical layer section to generate the self-IDs of the IEEE 1394 devices which are connected to the IEEE 1394 interface in succession; and
a link layer section to link the generated self-IDs to the corresponding IEEE 1394 devices.

25. The wireless bridge apparatus of claim 18, wherein the IEEE 1394 devices comprise a TV receiver, a VCR, a camcorder, a set top box, a DVD player, and/or a PC.

26. The wireless bridging method of claim 18, wherein the wireless interface uses ultra wideband (UWB) transmission technology to wirelessly communicate with the at least another wireless interface.

27. A wireless IEEE 1394 system, comprising:
first and second wireless bridge apparatuses, wherein each of the wireless bridge apparatuses comprise:
an IEEE 1394 interface,
a controller to control local bus reset, inter-bridge communication, and global bus reset operations,
a memory containing a routing table which stores self-IDs, and
a wireless interface to wirelessly communicate with the other wireless bridge apparatus.

28. The system of claim 27, wherein the IEEE 1394 interface is configured to connect to a plurality of IEEE 1394 devices.

29. The system of claim 28, wherein the IEEE 1394 interface connects to the plurality of IEEE 1394 devices by at least one cable.

30. The system of claim 28, wherein the wireless interface comprises:
a physical layer section to generate self-IDs corresponding to each of the plurality of IEEE 1394 devices which are connected to the IEEE 1394 interface in succession; and
a link layer section to link the generated self-IDs to the corresponding IEEE 1394 devices.

31. The system of claim 30, wherein the controller activates the local bus reset, inter-bridge communication, and global bus reset operations when an IEEE 1394 device is connected to or detached from the IEEE 1394 interface.

32. The system of claim 31, wherein the local bus reset operation comprises each of the plurality of IEEE 1394 devices which are connected to the IEEE 1394 interface generating and transmitting a self-ID to the routing table.

33. The system of claim 32, wherein the inter-bridge communication operation comprises the wireless interface transmitting self-IDs stored in the routing table to the other wireless interface, and receiving self-IDs stored in the other routing table from the other wireless interface.

34. The wireless bridge apparatus of claim 33, wherein the global bus reset operation comprises the wireless bridge apparatus generating new self-IDs based on the self-IDs stored in the routing table after the inter-bridge communication operation.

35. A wireless bridge apparatus, comprising:
an IEEE 1394 interface which is configured to connect to a plurality of IEEE 1394 devices; and
a wireless interface to wirelessly transmit and receive information to and from other wireless interfaces, wherein the IEEE 1394 devices have no bridge awareness function.

36. The wireless bridge apparatus of claim 35, wherein the IEEE 1394 interface connects to the plurality of IEEE 1394 devices by at least one cable.
